(19) United States
(12) Patent Application Publication
(10) Pub. No.: US 2023/0292701 A1
(43) Pub. Date: Sep. 21, 2023

(54) Pet Feeding Device

(71) Applicant: Pet Parents LLC, Ankeny, IA (US)

(72) Inventors: Taylor Shaw, Ankeny, IA (US); Blake Anderson, Ankeny, IA (US); Mikaela Stanley, Ankeny, IA (US)

(21) Appl. No.: 17/654,900

(22) Filed: Mar. 15, 2022

(51) Int. Cl. A01K 5/01

(52) U.S. Cl. CPC A01K 5/0114

(57) ABSTRACT

A pet feeding device includes a floor and a plurality of flexible members extending upwardly from the floor, each of the plurality of flexible members having a lower portion proximate to the floor and an upper portion that is distal therefrom. The plurality of flexible members are located across an upper surface of the floor to substantially conceal the upper surface of the floor. The plurality of flexible members are formed of a flexible fabric material and are movable in response to a pet searching for food on the pet feeding device.

### FIELD

This disclosure relates to the field of pets and pet feeding products. More particularly, this disclosure relates to a device for replicating foraging of food by a pet to aid in healthy feeding and cognitive stimulation of the pet.

### BACKGROUND

Feeding a pet from a traditional open bowl or other vessel may create problems that arise from the pet consuming contents of the bowl too quickly. For example, problems that may arise for a pet from consuming food to quickly include choking, vomiting, and bloating. Traditional open bowls or other similar vessels do not prevent problems that may arise from rapid consumption of contents of the bowls. Other issues may arise from a pet feeding out of an open bowl due to the ease of which the pet is able to obtain food from the bowl, thereby reducing mental stimulation that may normally occur during foraging or hunting for food.

Various attempts have been made to provide bowls or other containers that slow down feeding by a pet. However, existing attempts do not create a natural foraging or feeding experience for a pet that are also safe for the pet. Further, most existing attempts may create other health problems for the pet. For example, existing attempts to create bowls that slow feeding of a pet may induce buildup of bacteria on surfaces of the bowl and prevent the ability of the bowl to be fully cleaned. Many existing bowls are formed of harmful materials, such as BPA, phthalates, or other materials that may be toxic to pets.

Existing attempts to slow feeding of pets may also rely on a construction or otherwise use materials that are abrasive or rough on a face of the pet. For example, some bowls may use materials that are abrasive to faces, noses, and tongues of pets when used daily for feeding of the pet.

What is needed, therefore, is a device that slows eating by a pet while providing a realistic foraging experience for the pet that is safe and stimulating for the pet.

### SUMMARY

The above and other needs are met by a pet feeding device that slows eating by a pet and that allows the pet to forage for food or treats on the pet feeding device. In one aspect, a pet feeding device includes a floor and a plurality of flexible members extending upwardly from the floor, each of the plurality of flexible members having a lower portion proximate to the floor and an upper portion that is distal therefrom. The plurality of flexible members are located across an upper surface of the floor to substantially conceal the upper surface of the floor. The plurality of flexible members are formed of a flexible fabric material and are movable in response to a pet searching for food hidden or otherwise located on the pet feeding device.

The plurality of flexible members may be formed of a soft microfiber or chenille fabric. The pet feeding device may further include an anti-skid portion located on a bottom surface of the floor. The anti-skid portion may include a plurality of circular portions on the bottom surface of the floor.

The pet feeding device may further include a side wall extending upward from the floor, the sidewall located around the plurality of flexible members. The pet feeding device may include a channel located around an upper edge of the side wall and a drawstring located within the channel. A closure mechanism may also be included for securing the drawstring. The pet feeding device may include a pocket located on an outside of the side wall adjacent to the closure mechanism of the drawstring for receiving at least a portion of the drawstring therein.

A height of the side wall of the pet feeding device may be such that when the drawstring is pulled the upper edge of the sidewall is located at least partially over the upper portion of the plurality of flexible members. The floor of the pet feeding device may be formed of a durable oxford material.

The upper portion of the plurality of flexible members may have a diameter that is greater than a diameter of the lower portion of the plurality of flexible members. The plurality of flexible members located adjacent to sides of the floor may extend beyond side edges of the floor.

The pet feeding device may further include a strap having a first fastener portion located on a distal end of the strap and a second fastener portion located on a bottom surface of the floor. The pet feeding device may be rollable such that the first fastener portion is attached to the second fastener portion to secure the pet feeding device in a rolled configuration.

In another aspect, a pet feeding device includes a floor and a plurality of flexible members extending upwardly from the floor, each of the plurality of flexible members having a lower portion proximate to the floor and an upper portion that is distal therefrom, the plurality of flexible members formed of one of a soft-microfiber and chenille fabric. The plurality of flexible members are located across an upper surface of the floor to substantially conceal the upper surface of the floor. The plurality of flexible members are formed of a flexible fabric material and are movable in response to a pet searching for food hidden or otherwise located on the pet feeding device. Further, the plurality of flexible members are formed of a soft fabric and are movable in response to a pet feeding on the pet feeding device.

The pet feeding device may further include a side wall extending upward from the floor, the sidewall located around the plurality of flexible members.

The pet feeding device may include a strap having a first fastener portion located on a distal end of the strap and a second fastener portion located on a bottom surface of the floor. The pet feeding device is rollable such that the first fastener portion is attached to the second fastener portion to secure the pet feeding device in a rolled configuration.

In yet another aspect, a pet feeding device includes: a floor including an anti-skid portion located on a bottom surface thereof; a plurality of flexible members extending upwardly from an upper surface of the floor, each of the plurality of flexible members having a lower portion proximate to the floor and an upper portion that is distal therefrom, the plurality of flexible members formed of one of a soft-microfiber and chenille fabric; a side wall extending upward from the floor, the sidewall located around the plurality of flexible members; a channel located around an upper edge of the side wall and a drawstring located within the channel; a closure mechanism for securing the drawstring; and a pocket located on an outside of the side wall adjacent to the closure mechanism of the drawstring for receiving at least a portion of the drawstring therein. The plurality of flexible members are located across an upper surface of the floor to substantially conceal the upper surface of the floor. The plurality of flexible members are formed of a flexible fabric material and are movable in response to a pet searching for food hidden or otherwise located on the pet feeding device.

The plurality of flexible members may be formed of one of a soft-microfiber and chenille fabric. A height of the sidewall may be such that when the drawstring is pulled the upper edge of the sidewall is located at least partially over the upper portion of the plurality of flexible members. The floor may be formed of a durable oxford material.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a perspective view of a pet feeding device;

FIG. 2 shows a perspective view of a pet feeding device having portions with varying lengths of flexible members;

FIGS. 3A and 3B are cross-sectional views of a pet feeding device;

FIG. 4A is a top plan view of a pet feeding device in an open or expanded configuration;

FIG. 4B is a top plan view of a pet feeding device in a closed or collapsed configuration;

FIGS. 5A and 5B are side views of a pet feeding device;

FIG. 6 is a bottom plan view of a pet feeding device and a bottom surface of a floor thereof;

FIG. 7 is a close-up view of a closure mechanism and pocket of a pet feeding device;

FIGS. 8A and 8B are top plan views of a pet feeding device in the form of a mat;

FIGS. 9A and 9B are perspective views of a pet feeding device;

FIG. 10 is a side view of a pet feeding device and strap attached thereto;

FIGS. 11A and 11B are bottom views of a pet feeding device; and

FIG. 12 is a perspective view of a pet feeding device in a rolled configuration.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

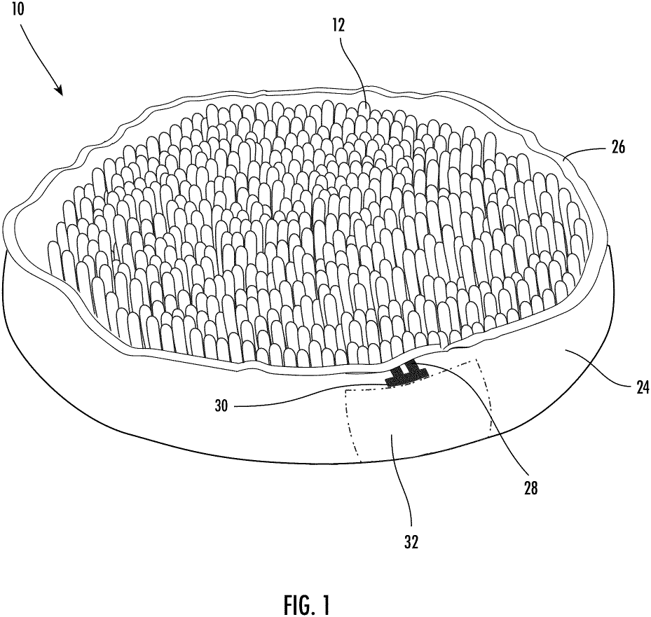

FIG. 1 shows a perspective view of a pet feeding device 10 adapted to contain food for a pet and to allow the pet to consume the food in a controlled manner. The pet feeding device 10 advantageously provides a realistic foraging experience during the consumption of food by a pet. The pet feeding device 10 is effective for substantially hiding or at least partially concealing food from the pet on the pet feeding device 10 while providing materials and a construction that make the pet feeding device 10 suitable for everyday use for feeding of the pet, or as an engaging or stimulating activity for the pet.

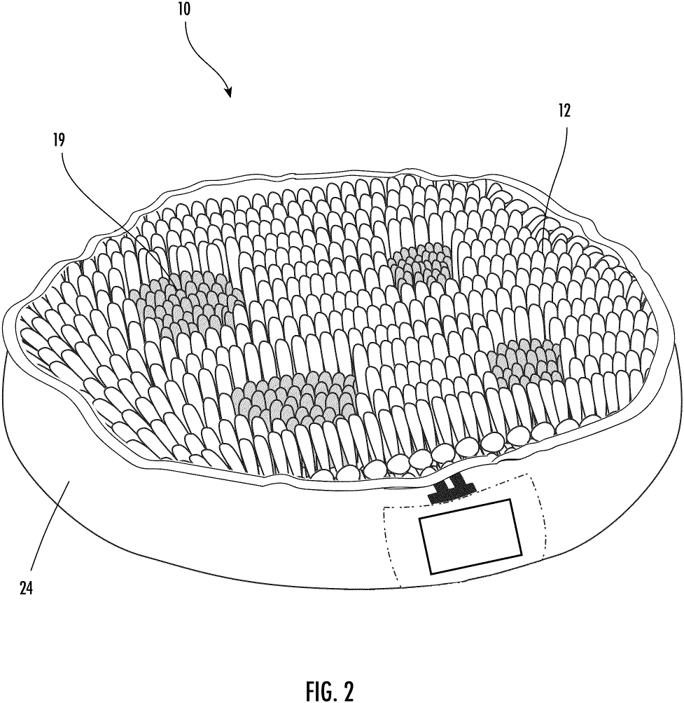

The pet feeding device 10 may be constructed in the form of a bowl, as shown in FIG. 1. The pet feeding device 10 may include a plurality of flexible members 12 located on the pet feeding device 10. The plurality of flexible members 12 are preferably formed of a soft and flexible fabric material. For example, the plurality of flexible members 12 may be formed of a soft-microfiber or chenille fabric. The plurality of flexible members 12 may be formed of a material having a weight of from about 2000 to about 2,500 grams per square meter (GSM). The plurality of flexible members 12 are closely spaced on the pet feeding device 10 such that the plurality of flexible members 12 substantially conceal a bottom surface of the pet feeding device 10, as shown in FIG. 2. The plurality of flexible members 12 may have a length of from about 1 cm to about 10 cm, and may either be consistent in length or vary across the pet feeding device as discussed in greater detail below.

The plurality of flexible members 12 may be elongate in shape and may have a diameter that is consistent along a length of the plurality of flexible members. Alternatively, each of the plurality of flexible members 12 may be shaped to include an upper portion 14. The upper portion 14 of the plurality of flexible members 12 may have a diameter or size that is greater than a lower portion 16 of the plurality of flexible members 12, thereby causing the plurality of flexible members 12 to substantially contact one another at the upper portion 14 of the plurality of flexible members 12 and substantially conceal a bottom of the pet feeding device 10 while allowing space to exist towards the lower portion 16 of the plurality of flexible members 12 for food or other items to be consumed by the pet.

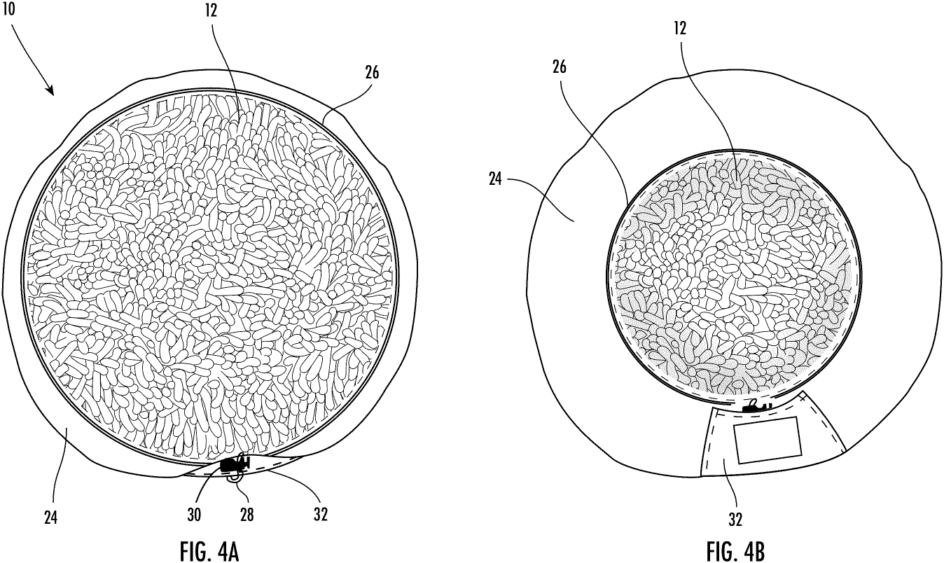

As shown in the top-down view of FIGS. 4A and 4B, the plurality of flexible members 12 may be closely spaced within the pet feeding device 10 such that the plurality of flexible members 12 abut one another and substantially conceal a bottom of the pet feeding device 10. The plurality of flexible members 12 are readily deformable or otherwise movable such that a pet may push its snout, or foot, through the plurality of flexible members 12 or otherwise move the plurality of flexible members 12 to forage for food located on the pet feeding device 10. Further, the plurality of flexible members 12 may be shaped to allow food or other items to rest towards a bottom of the pet feeding device 10. The plurality of flexible members 12 may further support pieces of food at varying depths between or on top of the plurality of flexible members 12 to allow consumption of the pieces of food by the pet.

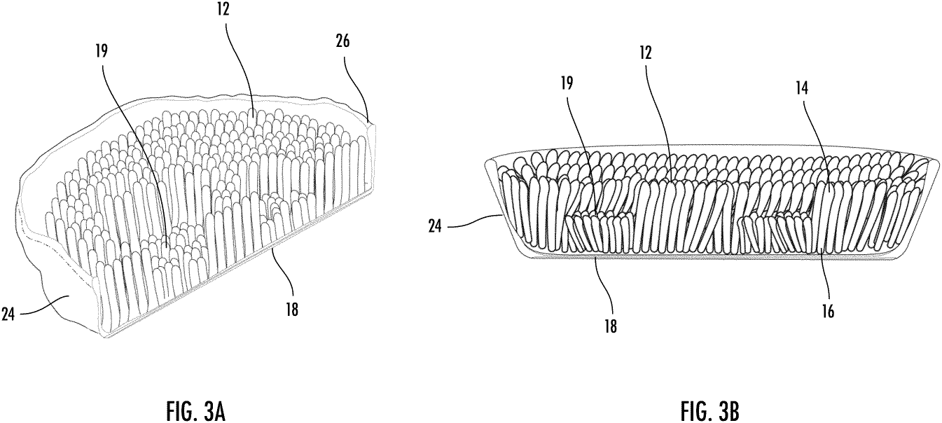

The plurality of flexible members 12 are secured on a floor 18 of the pet feeding device 10. The floor 18 of the pet feeding device 10 may be a planar surface adapted to receive the plurality of flexible members 12 thereon. The plurality of flexible members 12 are secured on the floor 18 such that the plurality of flexible members 12 extend upwardly from an upper surface of the floor 18, as shown in FIG. 3B. The plurality of flexible members 12 may be secured to the floor 18, such as by stitching or adhering the plurality of flexible members 12 to an upper surface of the floor. The floor 18 may be formed of a durable fabric material, such as durable oxford, to allow the pet feeding device 10 to be easily moved or shaped while preventing the floor 18 of the pet feeding device 10 from tearing during use.

The plurality of flexible members 12 may be substantially constant or similar in length across an area of the floor 18, as shown in FIG. 1. Alternatively, lengths of the plurality of flexible members 12 may vary, as shown in FIG. 2. For example, areas of the pet feeding device 10 may have portions of the plurality of flexible members 12 having lengths that are shorter than other portions. As shown in FIG. 2, shorter regions 19 may be defined within the plurality of flexible members 12 on the pet feeding device 10.

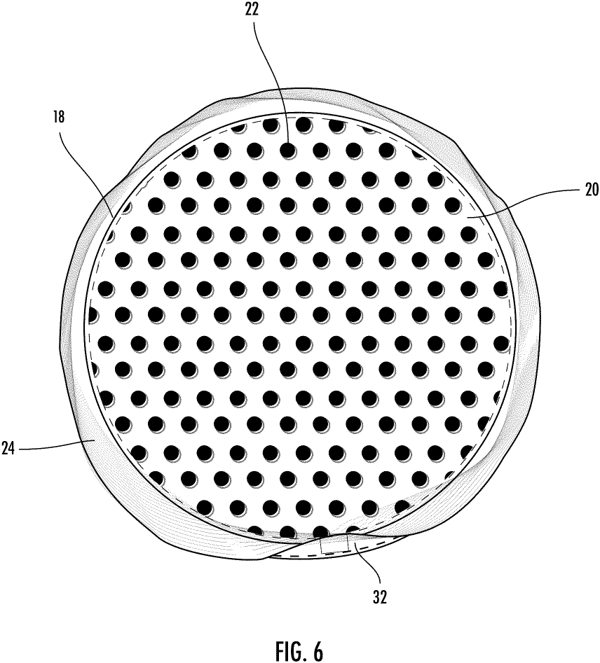

Referring to FIG. 6, a lower surface 20 of the floor 18 may be shaped to rest on a surface during use of the pet feeding device 10. The lower surface 20 of the floor 18 may be formed of a material that prevents sliding of the pet feeding device 10 when the pet feeding device 10 is resting on a surface, such as a hard surface. Alternatively, the pet feeding device 10 may include an anti-slip coating located or formed on the lower surface 20 of the floor 18. In another alternative, the lower surface 20 of the floor 18 includes one or more anti-slip or anti-skid portions 22 formed on the lower surface 20. For example, the one or more anti-slip portions 22 may be formed in a plurality of circular portions located across the lower surface 20 of the floor 18. It is also understood that the one or more anti-skid portions 22 may be formed in other suitable shapes or may be located across other various portions of the pet feeding device 10. The anti-skid portion 22 on the lower surface 20 of the floor 18 may be sticky or tacky to prevent moving or sliding of the pet feeding device 10 during feeding or use without leaving a residue and while further being easily movable when the pet feeding device 10 is lifted from a surface. For example, a PVC or silicone-based material may be located on at least a portion of the lower surface 20 of the floor 18 to prevent sliding of the pet feeding device 10. The material located on at least a portion of the lower surface 20 of the floor 10 may, for example, have a shore hardness of from about 15 to about 25A.

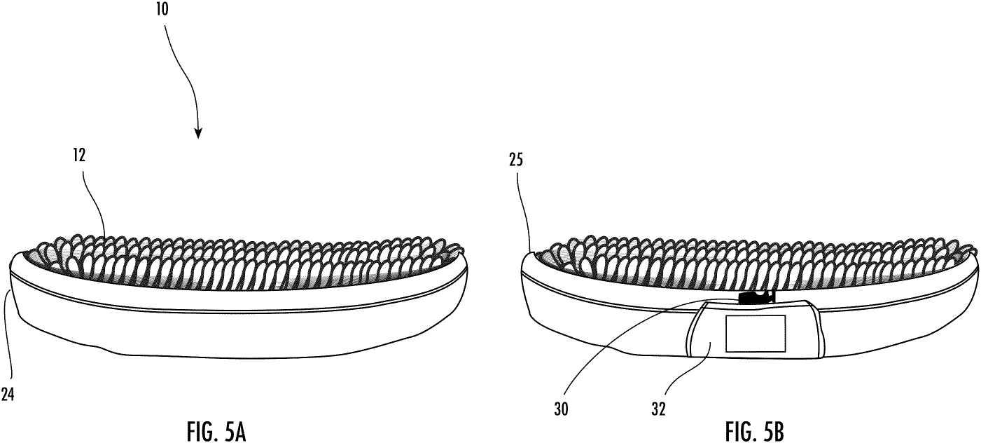

The pet feeding device 10 may take the form of a bowl, as shown in FIG. 1. The pet feeding device 10 may include a side wall 24 defining a side of the pet feeding device 10. The side wall 24 may be formed of a durable fabric material, such as a durable oxford material. The side wall 24 may be deformable such that the pet feeding device 10 may be folded or otherwise collapsed when not in use. As shown in FIGS. 5A and 5B, the side wall 24 may have a height such that the upper portion 14 of the plurality of flexible members 12 extend at least partially above a top edge 25 of the side wall 24. The side wall 24 may be deformable such that the side wall 24 may extend above the upper portion 14 of the plurality of flexible members 12 during transportation of the pet feeding device 10 and subsequently folded or pushed downward to expose at least a portion of the plurality of flexible members 12 when in use.

A sleeve 26 may be located around a top edge of the side wall 24. The sleeve 26 may circumscribe the plurality of flexible members 12 around the top edge of the side wall 24 and define a passage for receiving a drawstring 28 therethrough. The drawstring 28 may be located around the top edge of the side wall 24 through the sleeve 26. The drawstring 28 includes a clasp or closure mechanism 30 that is located along the side wall 24 for tightening or loosening the drawstring 28 in the sleeve 26.

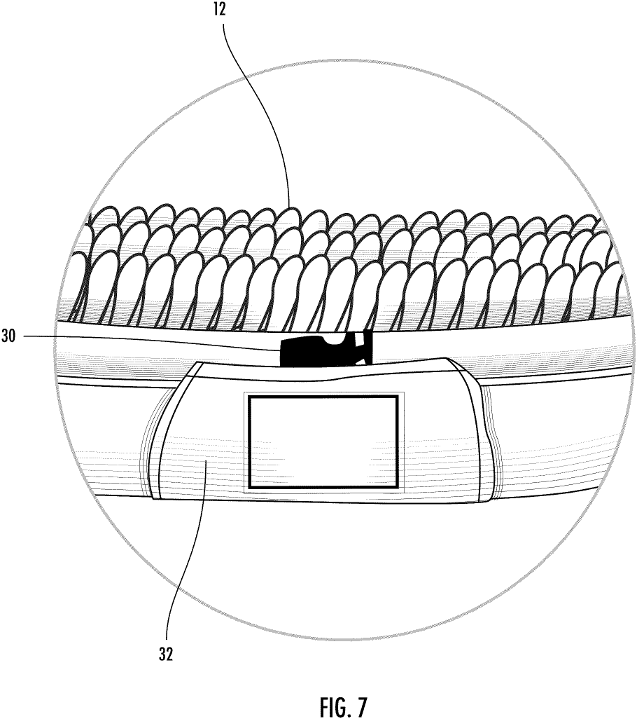

Referring to FIG. 7, the pet feeding device 10 may further include a pocket 32 located on an outer surface of the side wall 24. The pocket 32 may be located on the outer surface of the side wall 24 adjacent to the closure mechanism 30 of the drawstring 28. The pocket 32 is shaped to receive the drawstring 28 and may at least partially receive the closure mechanism 30 within the pocket 32. The pocket 32 substantially conceals the drawstring 28 and the closure mechanism 30 to prevent a pet feeding on the pet feeding device 10 from chewing or choking on the drawstring 28 when the pet feeding device 10 is in use.

When the pet feeding device 10 is in the form of a bowl, as shown in FIGS. 4A and 4B, the pet feeding device 10 may be collapsed or drawn closed when not in use and opened for use during feeding of a pet. As shown in FIG. 4A, in an open configuration the drawstring 28 may be loosened to allow the top edge of the side wall 24 to be widened to substantially expose the plurality of flexible members 12. Food or treats may be placed in the pet feeding device 10 and become embedded in the plurality of flexible members 12. A pet may consume the food or treats from the pet feeding device 10 by foraging through the plurality of flexible members 12. When not in use, such as during transportation of the pet feeding device 10, the drawstring 28 may be cinched to pull the top edge of the side wall 24 over at least a portion of the plurality of flexible members 12 as shown in FIG. 4B. In the closed position when the side wall 24 is drawn over the plurality of flexible members 12, remaining food or treats within the flexible members 12 may be substantially prevented from falling out of the pet feeding device 10.

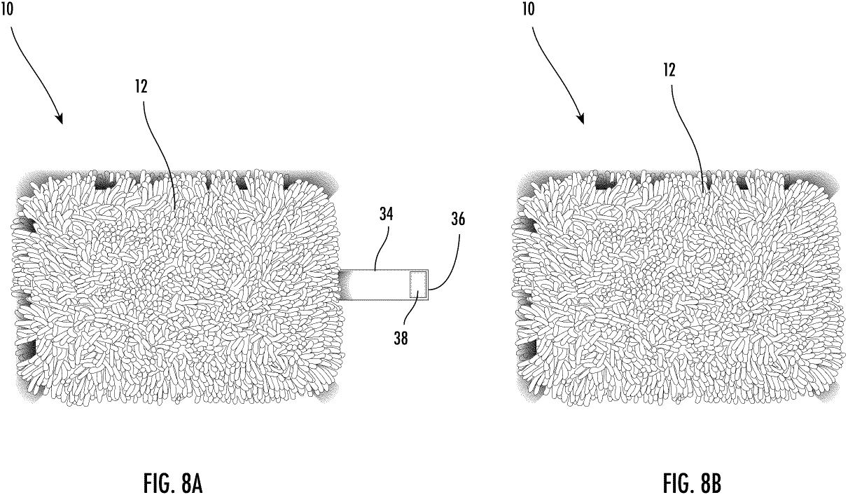

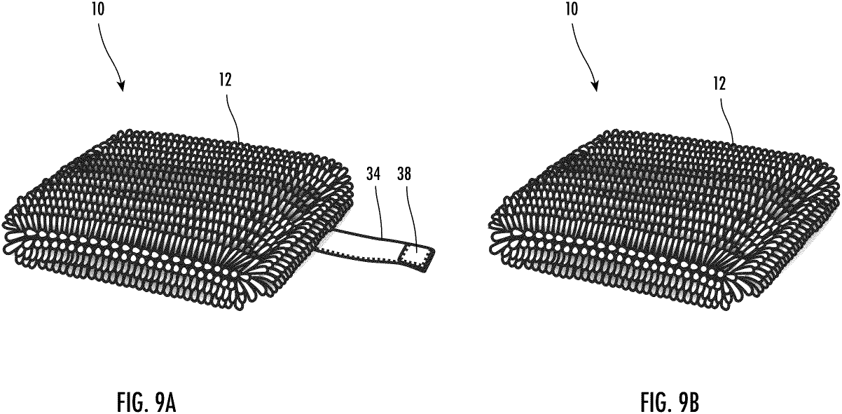

Referring now to FIGS. 8A and 8B, the pet feeding device 10 may be in the form of a mat or pad. The floor 18 of the pet feeding device 10 may be shaped to rest flat or substantially flat on a surface, such as a ground surface. The floor 18 may be bendable, rollable, or otherwise deformable such that the pet feeding device 10 may be folded or rolled when not in use as discussed in greater detail below. The plurality of flexible members 12 are secured on and extend generally upwardly from the floor 18 of the pet feeding device 10. In the form of a mat or pad, the plurality of flexible members 12 located along sides of the pet feeding device 10 may extend beyond side edges of the floor 18 to substantially conceal the floor 18, as shown in FIGS. 8A and 8B. For example, the plurality of flexible members 12 located along sides of the pet feeding device 10 may bend or fold outward from sides of the pet feeding device 10 to conceal sides of the floor 18 during use.

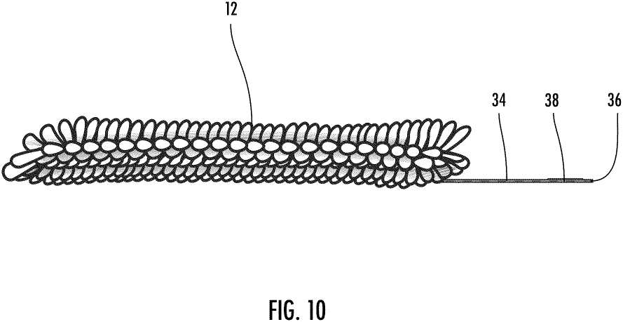

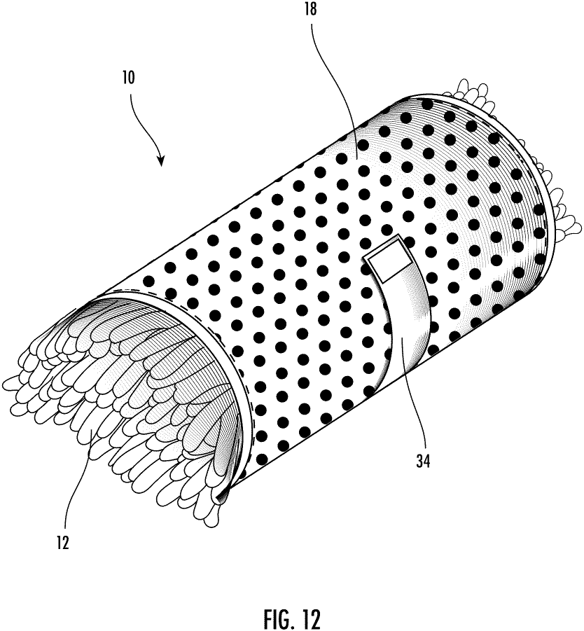

The pet feeding device 10 may include a fastener to secure the pet feeding device 10 in a rolled or folded configuration, as shown in FIG. 12. For example, the pet feeding device 10 may include a strap 34 extending from a side of the floor 18 as shown in FIG. 10. The strap 34 may be attached to the pet feeding device 10 at a first end of the strap 34. The strap 34 extends to a distal end 36 and may include a first fastener portion 38 located towards the distal end 36 of the strap 34. The first fastener portion 38 may be, for example, one of a hook or loop portion of a hook and loop fastener material. The first fastener portion 38 may be located on both an upper side of the strap 34 and a lower side of the strap 34 for securing the strap 34 to the floor 18 when the pet feeding device 10 is either expanded for use or in a rolled or stowed configuration.

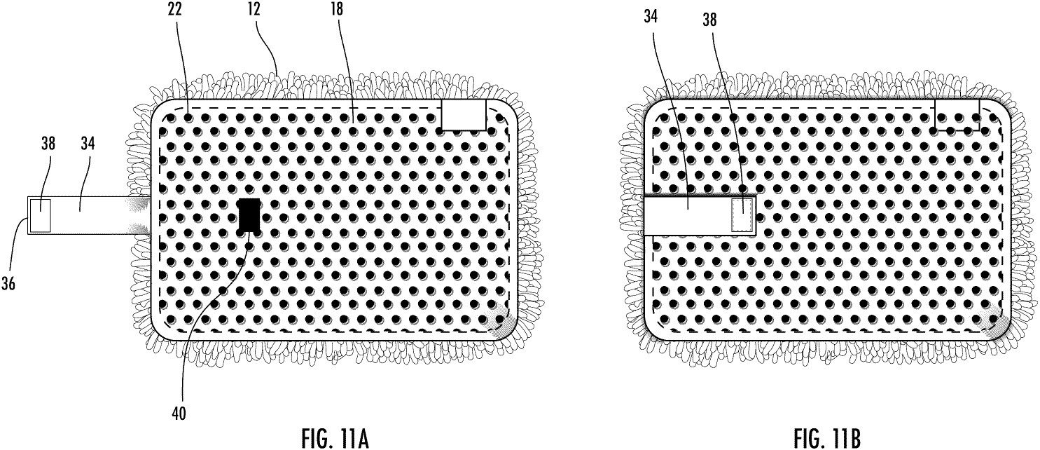

A second fastener portion 40 may be located on a bottom surface of the floor 18. The second fastener portion 40 may be located inward from side edges of the floor 18 such that the strap 34 may be folded against the bottom of the floor 18 as shown in FIG. 11B. The strap 34 may be secured on the second fastener portion 40 when the pet feeding device 10 is in an open or unrolled configuration to substantially conceal the strap 34 underneath the pet feeding device 10 when in use. The pet feeding device 10 may be rolled or folded as shown in FIG. 12. In a rolled or folded configuration, the pet feeding device 10 is rolled such that the plurality of flexible members 12 are facing inwards and the floor 18 facing outward. The strap 34 may be secured on the second fastener portion 40 in the rolled or folded configuration to secure the pet feeding device 10 in the rolled or folded configuration, such as when the pet feeding device 10 is not in use. In the rolled or folded configuration, any portions of food or treats that remain on the pet feeding device 10 are secured within the pet feeding device 10.

The pet feeding device 10 advantageously provides a device that may slow the feeding of an animal by requiring the animal to forage or snuffle through the plurality of flexible members 12 to locate and consume portions of food or treats embedded therein. The pet feeding device 10 substantially conceals portions of food or treats from the animal. The construction and placement of the plurality of flexible members 12 as described herein further prevents any irritation of a snout of the animal while the animal feeds on the pet feeding device 10. The pet feeding device is further readily stored for transportation, such as by allowing the pet feeding device to be rolled, folded, or collapsed when not in use. Further, construction of the pet feeding device 10 may be such that the pet feeding device 10 is machine washable or otherwise easily cleaned.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A pet feeding device comprising:
a floor;
a plurality of flexible members extending upwardly from the floor, each of the plurality of flexible members having a lower portion proximate to the floor and an upper portion that is distal therefrom;
wherein the plurality of flexible members are located across an upper surface of the floor to substantially conceal the upper surface of the floor;
wherein the plurality of flexible members are formed of a flexible fabric material and are movable in response to a pet searching for food on the pet feeding device.

2. The pet feeding device of claim 1, wherein the plurality of flexible members are formed of one of a soft-microfiber and chenille fabric.

3. The pet feeding device of claim 1, further comprising an anti-skid portion located on a bottom surface of the floor.

4. The pet feeding device of claim 3, wherein the anti-skid portion comprises a plurality of circular portions on the bottom surface of the floor.

5. The pet feeding device of claim 1, further comprising a side wall extending upward from the floor, the sidewall located around the plurality of flexible members.

6. The pet feeding device of claim 5, further comprising a channel located around an upper edge of the side wall and a drawstring located within the channel.

7. The pet feeding device of claim 6, further comprising a closure mechanism for securing the drawstring.

8. The pet feeding device of claim 6, further comprising a pocket located on an outside of the side wall adjacent to the closure mechanism of the drawstring for receiving at least a portion of the drawstring therein.

9. The pet feeding device of claim 5, wherein a height of the side wall is such that when the drawstring is pulled the upper edge of the sidewall is located over at least partially over the upper portion of the plurality of flexible members.

10. The pet feeding device of claim 1, wherein the floor is formed of a durable oxford material.

11. The pet feeding device of claim 1, wherein the upper portion of the plurality of flexible members has a diameter that is greater than a diameter of the lower portion of the plurality of flexible members.

12. The pet feeding device of claim 1, wherein the plurality of flexible members located adjacent to sides of the floor extend beyond side edges of the floor.

13. The pet feeding device of claim 1, further comprising:
a strap having a first fastener portion located on a distal end of the strap; and
a second fastener portion located on a bottom surface of the floor;
wherein the pet feeding device is rollable such that the first fastener portion is attached to the second fastener portion to secure the pet feeding device in a rolled configuration.

14. A pet feeding device comprising:
a floor;
a plurality of flexible members extending upwardly from the floor, each of the plurality of flexible members having a lower portion proximate to the floor and an upper portion that is distal therefrom, the plurality of flexible members formed of one of a soft-microfiber and chenille fabric;
wherein the plurality of flexible members are located across an upper surface of the floor to substantially conceal the upper surface of the floor;
wherein the plurality of flexible members are movable in response to a pet searching for food on the pet feeding device.

15. The pet feeding device of claim 14, further comprising a side wall extending upward from the floor, the sidewall located around the plurality of flexible members.

16. The pet feeding device of claim 14, further comprising:
a strap having a first fastener portion located on a distal end of the strap; and
a second fastener portion located on a bottom surface of the floor;
wherein the pet feeding device is rollable such that the first fastener portion is attached to the second fastener portion to secure the pet feeding device in a rolled configuration.

17. A pet feeding device comprising:
a floor including an anti-skid portion located on a bottom surface thereof;
a plurality of flexible members extending upwardly from an upper surface of the floor, each of the plurality of flexible members having a lower portion proximate to the floor and an upper portion that is distal therefrom;
a side wall extending upward from the floor, the sidewall located around the plurality of flexible members;
a channel located around an upper edge of the side wall and a drawstring located within the channel;
a closure mechanism for securing the drawstring;
a pocket located on an outside of the side wall adjacent to the closure mechanism of the drawstring for receiving at least a portion of the drawstring therein;
wherein the plurality of flexible members are located across an upper surface of the floor to substantially conceal the upper surface of the floor;
wherein the plurality of flexible members are movable in response to a pet searching for food on the pet feeding device.

18. The pet feeding device of claim 17, wherein the plurality of flexible members are formed of one of a soft-microfiber and chenille fabric.

19. The pet feeding device of claim 17, wherein a height of the side wall is such that when the drawstring is pulled the upper edge of the sidewall is located over at least partially over the upper portion of the plurality of flexible members.

20. The pet feeding device of claim 17, wherein the floor is formed of a durable oxford material.
